(19) United States
(12) Patent Application Publication
(10) Pub. No.: US 2012/0185482 A1
(43) Pub. Date: Jul. 19, 2012

(54) METHODS, SYSTEMS, AND COMPUTER READABLE MEDIA FOR DYNAMICALLY SEARCHING AND PRESENTING FACTUALLY TAGGED MEDIA CLIPS

(76) Inventor: Marc C. Sedam, Rye, NH (US)

(21) Appl. No.: 13/432,163

(22) Filed: Mar. 28, 2012

Related U.S. Application Data
(63) Continuation of application No. 12/370,489, filed on Feb. 12, 2009.
(60) Provisional application No. 61/028,092, filed on Feb. 12, 2008.

(51) Int. Cl. G06F 17/30

(52) U.S. Cl. 707/738; 707/E17.009; 707/E17.014

(57) ABSTRACT

The subject matter described herein includes methods, systems, and computer readable media for dynamically searching and presenting factually tagged media clips. According to one aspect, a method for providing dynamic user access to factually tagged media portions of a media presentation is provided. The method includes dividing a media presentation into media portions and factually tagging the media portions. The factually tagged media portions are stored in a database and dynamic user access to the factually tagged media portions is provided. The user dynamically accesses, via a fantasy sports game interface, the tagged media portions stored in the database by engaging in a dialogue with at least one server associated with the database and retrieving portions of the media presentation in response to user queries.

### PRIORITY CLAIM

This application is a continuation of U.S. Patent Application Number 12/370,489, filed Feb. 12, 2009, which claims the benefit of U.S. Provisional Patent Application Number 61/028,092, filed on Feb. 12, 2008. The disclosures of each of these Applications are incorporated herein in their entirety.

### TECHNICAL FIELD

The subject matter described herein relates generally to fantasy sports games. More particularly, the subject matter described herein includes methods, systems, and computer readable media for dynamically searching and presenting factually tagged media clips in fantasy sports games.

### BACKGROUND

Sports occupies a prominent place as an entertainment option for many people. For decades, the majority of the most-watched programs on television were sporting events. Even with the advent of the Internet, broadband access, and the reduction in cost of high-performance computers, broadcasts of sporting events still obtain many of the highest ratings on a weekly basis.

Consumers have always looked for additional ways to consume sports content, starting with early card-based games like Strat-O-Matic. In Strat-O-Matic (which came in both baseball, football, and basketball), statistics from the prior season were distilled down into “cards” which represented each player's abilities in a given situation. By nature of the process, Strat-O-Matic games were completely influenced by historical performance and had no real-time component of the games being played.

The next big leap in simulated sports was the creation of fantasy sports leagues. Led by football (founded in 1962 by three people affiliated with the Oakland Raiders) and followed in 1980 when “rotisserie” baseball was created (by Daniel Okrent, whose league met in a New York restaurant called ‘La Rotisserie Francaise’, hence the name), fantasy sports applied the concept of following the current league season and awarding points based on weekly performance of players. Fantasy sports gained quickly in popularity but was a labor-intensive process as one person, usually the league's ‘commissioner’ would pore through box scores and game statistics to determine performance and award points. Leagues award championships based on each fantasy team's ability to beat the other team by having a roster generate more fantasy points in a given week.

The advent of high-performance computers and the ubiquity of broadband Internet access permitted another advance in the fantasy sports experience—that of having websites do much of the work on your behalf. At present, thousands of fantasy sports websites allow you to choose rosters, draft players (through a straight draft, draft with a salary cap), make (limited or unlimited) trades, and treat your fantasy sports “team” as if it were a real team of players who rely the team owner to make moves in an effort to win games and ultimately the league title. Calculating points and tracking performance is now as simple as uploading your fantasy roster to the website of choice and logging in after each game to track the progress and accumulation of points.

One other advance in fantasy sports, also based on the ubiquity of high-performance computers, is the ability to play more and more realistic simulations on a home computer. Every major professional sport around the globe has at least one video game simulation where players can use joysticks (or other input devices) to control the virtual player and perform against other players or against the computer's artificial intelligence to win simulated games. At the core, these simulations are more similar to the Strat-O-Matic games than to modern-day fantasy sports as the performance of the athlete's avatar in the game is dictated by a collection of performance and subjective rankings of specific attributes (e.g. speed, throwing ability, etc.) created by the game authors.

There is a strong desire from consumers of sports content to become more and more immersed in the performance of professional (and now, increasingly, amateur) athletes. The rise of fantasy sports has created a generation of fantasy players looking at sophisticated methodologies to get an edge in performance of their fantasy team. Much of the progress to date has been focused on sophisticated statistics which look for hidden predictors of performance in previously collected numbers. For example, the early fantasy baseball sites tracked a player's home runs and RBIs as performance metrics on which to award points. So the best way to draft a high-performer for a fantasy team would be to look historically at those players with the highest home run and RBI totals over the past few years. However, a better predictor of a player's future performance might now be OPS (on-base percentage plus slugging percentage) which takes into account the number of times a player gets on base (predicting runs scored) as well as the number of total bases generated ([singles+doubles+triples+homeruns]/times at bat). Yet OPS is a calculation nearly unheard of a decade ago. Many existing sites and fantasy games offer this content, but consumers are still seeking out differentiation in the field.

Despite all the advances in statistics, the excitement of sports still rests with the on-field action. The deficiencies of the above-mentioned activities are that they either exist entirely on paper or on a basic HTML website, or that they are completely unlinked to the actual sporting events of the day/week/month. To date, no one has been able to connect the growing participation in fantasy sports with the exciting visual aspects of a game's performance.

Accordingly, a need exists in the art for a fantasy sports game which incorporates live action video from each game, linked with the fantasy implications of that video clip. Such a game would be accessible online and in as real-time as possible, so that a great play which “scores” fantasy points can not only be identified but seen by the fantasy owner.

### SUMMARY

The subject matter described herein includes methods, systems, and computer readable media for dynamically searching and presenting factually tagged media clips. According to one aspect, a method for providing dynamic user access to factually tagged media portions of a media presentation is provided. The method includes dividing a media presentation into media portions and factually tagging the media portions. The factually tagged media portions are stored in a database and dynamic user access to the factually tagged media portions is provided. The user dynamically accesses, via a fantasy sports game interface, the tagged media portions stored in the database by engaging in a dialogue with at least one server associated with the database and retrieving portions of the media presentation in response to user queries.

According to one aspect, the subject matter described herein includes a new fantasy sports game which incorporates live-action video that is correlated to the in-game performance of the fantasy owner's players. In one implementation of the subject matter described herein, the game provides for a fantasy owner drafting/compiling a team of players for a given sport under the rules of the fantasy league.

According to another aspect of the subject matter described herein, a method of tracking performance of a player by not only viewing the statistics of said player's performance, but by having live-action video linked to the discrete plays made directly by that player is provided.

According to another aspect of the subject matter described herein, a method of searching for a specific player's performance criteria across time intervals (e.g. plays within a game, games, seasons, careers) and generating live-action video directly relating to those statistics is provided. One feature of this aspect of the subject matter described herein includes the generation of an entire new subset of statistics based on the initial search which can also be mined for specific performance attributes.

According to yet another aspect of the subject matter described herein, a method for embedding tags within the video of a complete event based on relevant fantasy sports statistics and having this video easily searchable based on the statistical events in that performance. One implementation of this aspect of the subject matter described herein includes sorting multiple performance-based metrics out of a single video, such that only the video that meets the performance criteria is available for viewing.

According to yet another aspect of the subject matter described herein, a method of limiting the searching of video by total running time such that the fantasy owner could not recreate actual complete games by performing multiple searches is provided.

According to yet another aspect of the subject matter described herein, a method of automatically tracking key performance metrics related to the players (or collection of players), identifying the video relating to those metrics, compiling a “highlight reel” of performances by all players on the fantasy team, and uploading or otherwise connecting that video compilation in an easily accessible format (e.g. fantasy owners' home page or main account page) is provided. One implementation of this aspect of the subject matter described herein includes the communication (via text message, email, or other suitable form) of the completion of the compilation along with a hyperlink to automatically view said video on a computer, TV, or convergent device.

The subject matter described herein for dynamically searching and presenting factually tagged media clips can be implemented using a computer readable medium having stored thereon instructions that when executed by a processor of a computer control the computer to perform steps. Exemplary computer readable media suitable for implementing the subject matter described herein include chip memory devices or disk memory devices accessible by a processor, programmable logic devices, and application specific integrated circuits. In addition, a computer readable medium that implements the subject matter described herein may be located on a single computing platform or may be distributed across plural computing platforms.

### BRIEF DESCRIPTION OF THE DRAWINGS

The teaching of the present invention can be readily understood by considering the following detailed description, in conjunction with the accompanying drawings in which:

FIG. 1 is a block diagram of an exemplary system for dynamically searching and presenting factually tagged media clips according to an embodiment of the subject matter described herein;

FIG. 2 is a flow chart of exemplary steps for dynamically searching and presenting factually tagged media clips according to an embodiment of the subject matter described herein;

FIG. 3 is a flow chart of exemplary steps for capturing, converting, and tagging media content according to an embodiment of the subject matter described herein;

FIG. 4 is a flow chart of exemplary steps for automatically tagging a broadcast video source according to an embodiment of the subject matter described herein; and

FIG. 5 is flow chart of exemplary steps for performing nested searches and displaying an interactive box score according to an embodiment of the subject matter described herein.

### DETAILED DESCRIPTION

In one embodiment, the subject matter described herein relates to the creation of a new fantasy sports game which incorporates live-action video. Elements of the subject matter described herein include the tagging of live-action games wherein all of the relevant fantasy sports elements are tagged for the entire performance for all players or collections of players in a specific game. The video is captured from any available source (e.g. television, satellite, Internet-based video) and compressed to optimize for viewing on a personal computer or convergent device. The entirety of each game may be tagged for every discrete event that happens and these tags are embedded in the video (either the raw video or the compressed video) making the entirety of the video searchable for discrete events in innumerable ways. For example, in American football a pass from the quarterback to the wide receiver for a touchdown could be extracted from the entire event by searching for (a) touchdown throws by the quarterback, (b) passes attempted by the quarterback, (c) completions by the quarterback, (d) receptions by the wide receiver, (e) touchdown receptions by the wide receiver, or (f) touchdowns given up by the opposing team's defense. Any of these multivariate searches would obtain the output of the same video clip.

One embodiment of subject matter described herein provides for searching video files across performances, be they within games, among games, or among seasons. Searching the video files based on a specific performance metric will generate a video-based representation of that performance (e.g. touchdowns scored by an American football wide receiver). In one aspect of this invention, the newly compiled video which resulted from the initial search itself generates an entire new subset of statistics which can be viewed as a text-based or HTML-based (or any other output that can be read) and which relate only to the video compilation. The video of this performance subset can also be sorted by using the text-based or HTML-based output, which would generate an additional subset of the video information which can be viewed or further searched. In this way, performance can be viewed from multivariate searches and subsets of that search to view discrete actions within the complete performance which are of interest.

One embodiment of the subject matter described herein includes the creation of customized video compilations (“highlights”) based on the fantasy-related performance of players on the owner's roster. In a specific embodiment, these compilations are automatically generated based on a time interval (e.g. daily, weekly, monthly, season-long) and are linked to key fantasy-related events. This video compilation is automated and the existence of a new compilation is communicated to the owner via hyperlink which can be delivered in an email, text message, RSS feed, or other communication methods.

Unlike existing fantasy games, the embodiments of the subject matter described herein intimately links the live-action video with the fantasy-based performance resulting in a more immersive and more “real” experience to the fantasy owner. The embodiments of the subject matter described herein take advantage of many different formats in which people consume sports content and packages it in an exciting format which can be accessed by the neophyte or expert consumer of content.

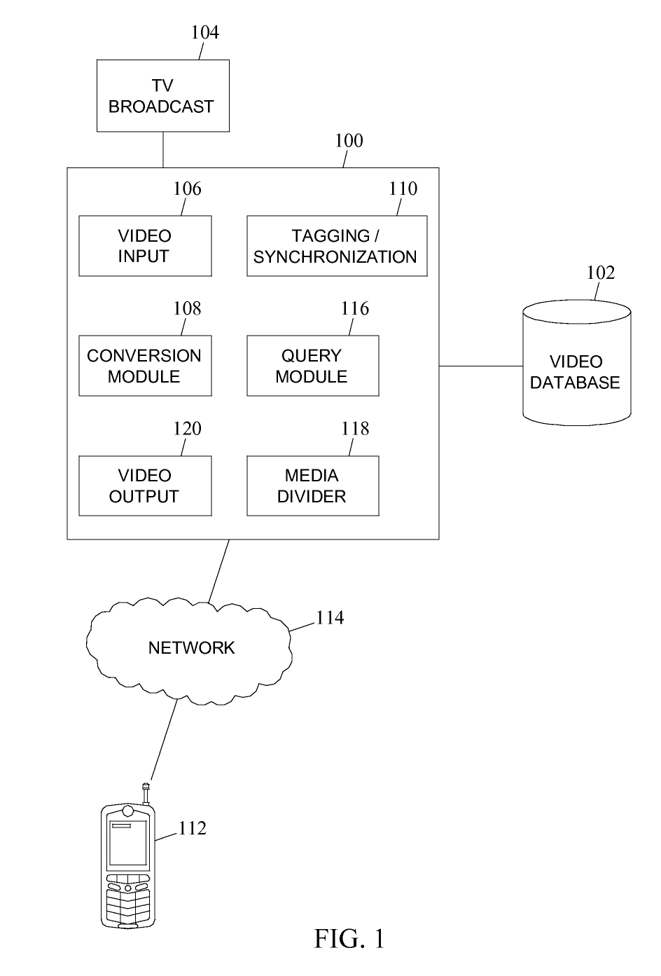

FIG. 1 is a block diagram of an exemplary system for dynamically searching and presenting factually tagged media clips according to an embodiment of the subject matter described herein. Referring to FIG. 1, dynamic user access module 100 may receive, format, and deliver video content to users as well as process search queries for factually tagged media clips. For example, dynamic user access module 100 may be connected to vide database 102 that stores media content, such as one or more factually tagged video clips. It is appreciated that dynamic user access module 100 may be located on a variety of hardware platforms, such as one or more blades and/or servers, without departing from the scope of the subject matter described herein. Additionally, while the embodiment shown in FIG. 1 illustrates that video database 102 is located remotely from dynamic user access module 100, video database 102 may be co-located or integrated with dynamic user access module 100.

Video database 102 may be any suitable data storage entity for storing the factually tagged media. For example, video database 102 may comprise and array of one or more hard disk drives, and a processor and memory for executing SQL database software. Files types that may be stored in video database 102 may include, but are not limited to, digital video, moving picture experts group (MPEG) video, QuickTime video, and flash video. Video content queries may be processed by video database 102 by performing a search for one or more factual tags associated with video clips. In one embodiment, such video queries may be received from dynamic user access module 100, and more specifically from query module 116.

Returning to user access module 100, one or more modules may be included within module 100 for performing discrete functions as described herein. In the embodiment shown in FIG. 1, video input module 106 may receive video input for eventual association with one or more factual tags. For example, video input module 106 may receive video content from broadcast television source 104, such as an over the air ATSC or NTSC broadcast signal or digital video files stored on a computer readable medium. In an alternate scenario, video input module 106 may receive user-generated video content from user 112, such as VHS videotape of a high school sports event.

Conversion module 108 may process video content received by input module 106. For example, analog video content may be converted into a common digital file format for easier processing. Conversion module 108 may also compress or otherwise optimize video content for storage in database 102. Upon conversion into an appropriate format, video content may be factually tagged and synchronized with one or more events within a longer video file.

Video tagging/synchronization module 110 may tag (i.e., associate) one or more factual tags with video content. For example, tagging module 110 may add metadata to video content and time information for determining which portion of the media presentation is to be associated with a particular piece of metadata. For example, a video may include an entire baseball game, and each at bat within the baseball game may have one or more associated statistics, such as batting average, balls, strikes, pitch speed, etc. It is further appreciated that non-factual information may be tagged to video clips. For example, users may vote on whether a particular sports event is the “highlight of the week” or “best performance of the month,” etc. Fantasy points may optionally be awarded based on this subjective information as well as factual information.

Factual tagging may be performed manually or automatically. Manual tagging may be performed by human operators who watch the video content and manually add appropriate metadata for each event with the media presentation. Automatic tagging may be performed, for example, by receiving a complete set of statistical information associated with the entire media presentation (i.e., an entire baseball game) and performing image/video analysis in order to automatically synchronize the data with time periods within the media presentation. In either scenario, additional quality control measures may be performed in order to ensure that tagging and/or synchronization is accurate. Tagged video content may be stored in video database 102 until a search query is received.

Upon receiving a video query, query module 116 may communicate with video database 102 in order to locate media content. Queries may be single variable or multivariate, depending on the number of clips the user wishes to see. In one embodiment, search results may include an entire media presentation rather than a time-limited media portion (i.e. a video clip). Therefore, a search for highlights of Alex Rodriguez's at bats this week may result in a search result including the video content for each game occurring this week in which he had an at bat. This video result may then be passed to media divider module 118 for separation into time-limited media portions for presentation to user 112. Additionally, it is appreciated that multiple queries may be performed sequentially (i.e. a first set of search results may be subsearched) in order to locate specific media content without departing from the scope of the subject matter described herein.

Media divider module 118 may divide a media presentation into one or more time-limited media portions based on user input. For example, a search for highlights of Alex Rodriguez's at bats this week may produce 12 results (i.e., four at bats per game for three games). Therefore, media divider may divide the media presentations associated with each of the three games into four media portions corresponding to each at bat. The length of the at bat may be determined by the user, and may include for example, from the first pitch to the last pitch or just the last pitch.

After the media presentation is divided into media portions, video output module 120 may format the video clips for presentation and/or delivery to user 112. In one embodiment, video output module may deliver one of an email, a short message service (SMS) message, a real simple syndication (RSS) feed, a multimedia message service (MMS) message, a uniform resource locator (URL), or a webpage including a hyperlink to the video resource. The video content may then be downloaded or streamed to user 112 in an appropriate format. Exemplary formats include flash video, real video, motion picture experts group (MPEG) video, and windows media video (WMV). It is appreciated that user 112 may include any suitable display device, such as a mobile telephone or personal computer.

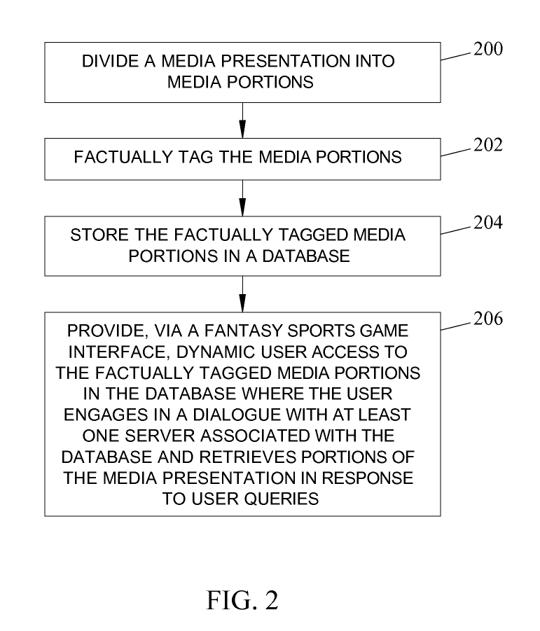

FIG. 2 is a flow chart of exemplary steps for dynamically searching and presenting factually tagged media clips according to an embodiment of the subject matter described herein. Referring to FIG. 2, in block 200, a media presentation may be divided into media portions. For example, a media presentation may include a single video file associated with an entire sports event, such as a baseball game. The media presentation may be divided into multiple media portions corresponding to discrete events within the game. For example, media portions may correspond to at bats, innings, or any other suitable criteria.

In block 202, the media portions are factually tagged. For example, one or more items of statistical information may be associated with the media portions by adding metadata to the video files. As described above, tagging may be performed manually or automatically and measures may be taken to ensure synchronization between data tags and video content.

In block 204, the factually tagged media portions are stored in a database, such as video database 102. Media portions are retrievable by, for example, single variable or multivariate data tag queries. Exemplary searches may include locating all media portions of Alex Rodriguez's at bats during a given week, or all home runs hit in the year 2000 by players having a batting average above 0.250.

In block 206, dynamic user access to the factually tagged media portions stored in the database is provided. A user engages in a dialogue with at least one server associated with the database and retrieves portions of the media presentation in response to user queries. This may include one or more SQL queries that may be processed by query module 116 on dynamic user access module 100. The dynamic user access may be provided via a fantasy sports game interface where the user engages in a dialog with at least one server (such as one or more servers on which dynamic user access module 100 is implemented) associated with the database (such as database 102) that stores factually tagged media clips. and retrieves (via the server) the media portions from the database. The fantasy sports game interface may be any suitable interface provided by dynamic access module 100 for accessing stored media portions. For example, the interface may range from a simple query box and search button presented to the user via a mobile phone or other suitable user device to a fantasy sports web site where the user can store the user's fantasy players, rosters, and through which the user can access media portions stored in database 102 for the user's fantasy players and/or rosters.

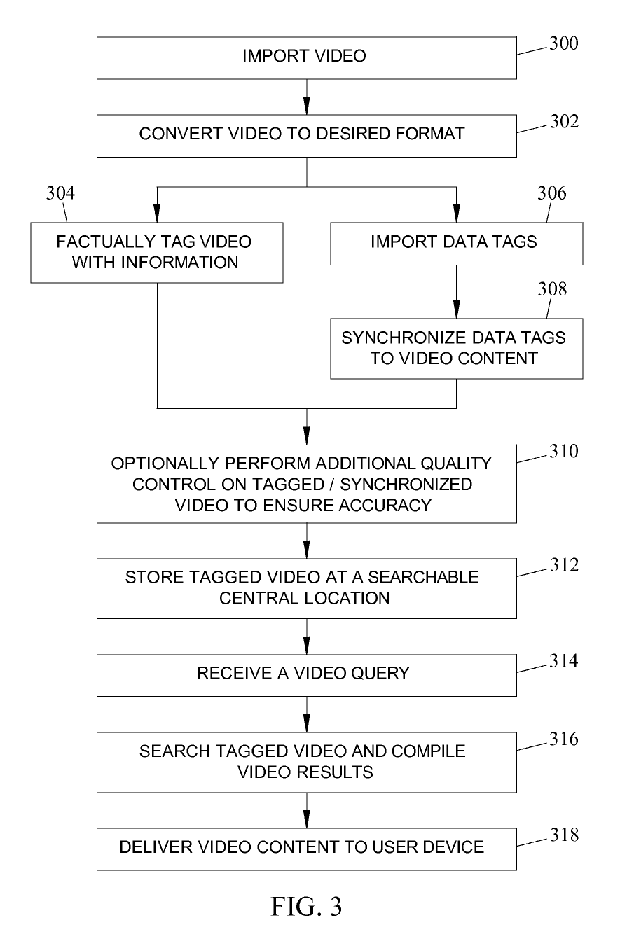

FIG. 3 is a flow chart of exemplary steps for capturing, converting, and tagging media content according to an embodiment of the subject matter described herein. Referring to FIG. 3, in block 300, a media presentation may be imported corresponding to a sports event. For example, the received media presentation may include a video file from a variety of sources. In one embodiment, a live-action event first broadcast (analog, digital, cable, or satellite) may be captured to computer-based storage media in its native format. This format may be raw video or any agreed-upon digital media format throughout the world, but in any event said video must be amenable to capture. Broadcasters can be the professional sports leagues themselves, individual teams who own the rights to their own performances, or the leagues' broadcast partners which pay for the rights to (re)broadcast these performances. Such broadcast may be generated by a sports league or its media sponsor which purchased rights to distribute the broadcast through the distribution channel of choice. It is known to one skilled in the art that some leagues may, in addition to broadcasting games may also capture the video and convert that video to a format viewable via a web browser. Media-based broadcasters may also deliver their content in multiple formats, or may store the broadcast at a central location and make it accessible via the Internet as well. It is appreciated that this model relies on the broadcast being delivered in its entirety and assumes that the consumer wishes to have the unedited broadcast available on their display device. In contrast, if the video received in block 300 is pre-edited and delivered as broadcast-defined highlights, then the consumer only gets to see that part of the game deemed important by a video editor.

The capturing of the video may be done automatically or manually, depending on the available technology. For example, video capture can be done with a video capture card, hardware which can convert video between standard formats as it is being captured, or with software which may convert video data between formats. Examples of standard video formats, but not an exhaustive compilation, are digital video (.DV), several iterations of MPEG (.MPG), QuickTime (.MOV), or Flash Video (.FLV).

According to another embodiment, fantasy owners may upload user-generated content for tagging and synchronization. The synchronized video may be provided by the website owner as part of the business model. Professionally captured video is generally of high-quality and may attract consumers to the website described herein as being a central location for high quality factually tagged sports video highlights. However the rise of user-generated video cannot be ignored. In this example, a fantasy owner may actually attend the live-action game in which one of the players on their fantasy team is playing. The website tracks that players performance in step and generates the live-action video relating to that statistic.

The fantasy team owner may find it interesting and exciting to share this user-generated content of the owner's “at the game” experience with other fantasy owners. In a specific embodiment, a fantasy owner would identify the video segment of the game which represents the same event as captured by the user. For example, the consumer may have seen a particularly exciting bicycle kick at a soccer match and have it captured by a portable display device or other digital medium. After logging in to the system, the consumer locates the same event via search and has the option to upload their content and associate it with the synchronized video clip. All attributes of the synchronized video clip will be automatically associated with the user-generated clip, making the user's content a part of the searchable database of video. The user-generated content could potentially also generate additional fantasy points for the team owner if their user-generated content fits specific, defined criteria for the appropriate time-interval as in step. In a specific embodiment, a clip that is in the top 10 most emailed links by users may generate an additional 10 fantasy points for the owner.

In block 302, the imported video may be converted to optimize the combination of file size and portability across devices. For example, an uncompressed video format may be reduced in size by one or more of reducing the resolution of the video or converting the video format to a video format having a higher compression ratio. Thus, for large high definition screens, such as high definition televisions or large computer monitors, minimal resolution reduction and compression may be desirable, while it may be more effective for small, low-resolution screens such as portable phones and laptop screens to greatly reduce the resolution and/or compress the video suitable for these devices.

In blocks 304 or 306-308, the converted video may be tagged either manually or automatically. For example, in block 304, one or more human operators (hereinafter, “taggers”) may watch the sports media presentation and manually associate one or more factual data tags corresponding to events within the media presentation. For example, in a media presentation comprising a video recording of a baseball game, a tagger may edit metadata associated with the video file corresponding to conventionally tracked baseball statistics, such as batting averages, strikeouts, pitch counts, hits, runs, etc.

In this embodiment, the captured video is tagged using searchable data which links the live-action video to the discrete events which represent the action. These data tags are synchronized with the live-action video such that the video can be searched and compiled based on the tagged data. The captured video must be tagged with data which will identify and summarize the discrete live-action event with a previously-defined data set. An example of data tags for video for a representative game of golf for an individual player might be total strokes, strokes per hole, and strokes using a particular club (e.g. 1-wood, 5-iron, or putter). These data tags would allow a user to search for total strokes on a given hole across players, initial shots by a specific player, or any video compilation showing all shots comprising an eagle (two shots under par) for any player. Any data set of interest, including data which represents the creation and compilation of fantasy points, can be searched.

In another embodiment, tagging may be performed automatically via standard video tagging software which identifies discrete performance-based events in the video. For example, in block 306, statistical information which may be formatted as one or more factual data tags, may be imported from a third party source. These data tags may be generated and imported directly from sports league sources such as MLB, NFL, NBA, etc. or from other reliable reporting sources. In block 308, data tags may be synchronized with the media presentation such that individual events within the media presentation may be associated with the correct factual information. For example, data associated with a particular at bat in a baseball game may be synchronized with a start and end time within the media presentation during which the at bat occurred.

Synchronizing the data tags to the video may be performed manually or automatically. By example, a person can watch the captured video in real time or from a recording and associate data tags with discrete events in the live-action video manually using standard video editing software or software specifically created for the purpose of generating these tags. Another example of generating data tags and synchronizing to the video would be by obtaining an officially sanctioned recap of the events which occurred in the live game. This data, provided by some leagues, ensures that the data representation of the game events is accurate and acts as a quality control mechanism for media outlets which report the summaries of events. Such data can be imported into the video as data tags through the use of software specifically designed for such a task. This method can reduce the time and cost of creating the data tags and may also act as a suitable quality control method to ensure that the statistical representation of the live-action video is accurate.

In either a manual or automated tagging scenario, according to block 310, additional quality control measures may optionally be taken in order to ensure the accuracy of the tagged/synchronized video content. The synchronized video which is stored in a central location (e.g. LAN, SAN, distributed network, etc.) may also be subject to quality control whereby the officially sanctioned data file summarizing the event can be compared to the summary data which can be automatically generated from the tagged video by searching for summary events. By example, in basketball one can compare the official box score which contains (again, by example) total free throws made and total free throws attempted, to the summary data for free throws made and attempted generating from the synchronized video. If the data outputs are identical, the synchronized video can be considered as having passed quality control and made accessible widely via the Internet.

In block 312, the tagged video is stored at a central location and the files can be made accessible over the Internet via a website and accessed through a standard web-based browser. The tagged video can then be searched from within the website for the desired content and the video and statistical compilation can be delivered to any Internet-connected display device. The synchronized video can be transmitted to the central location by standard file transfer protocols. Alternatively the captured video can be combined with the data tags directly on the central storage location and synchronized in real-time either manually or automatically.

In block 314, a video query may be received. Video tagging data may be embedded with the video when it is stored in a central location to be made accessible through a website. This tagged content makes the delivery of content entirely user-defined based on real-time searches of the video based on the pre-defined aspects of the event as it relates to fantasy sports. Thus delivery of this tagged content to a display device is limited only by the interest level of the user and possibly by time limits imposed on the search so as not to compete with over-air broadcasters. For example, suppose a content consumer/fantasy owner is interested in the prior week's performance of their fantasy soccer team and wishes to search the tagged video for all instances of goals scored by their players. The owner can open a web-browser and search for goals scored and have that compilation delivered to a web-enabled phone.

In block 318, the compiled video results may be delivered to the user's display device. Exemplary display devices may include a PC, web-enabled phone, or other convergent device with access to the Internet or the ability to store and replay content.

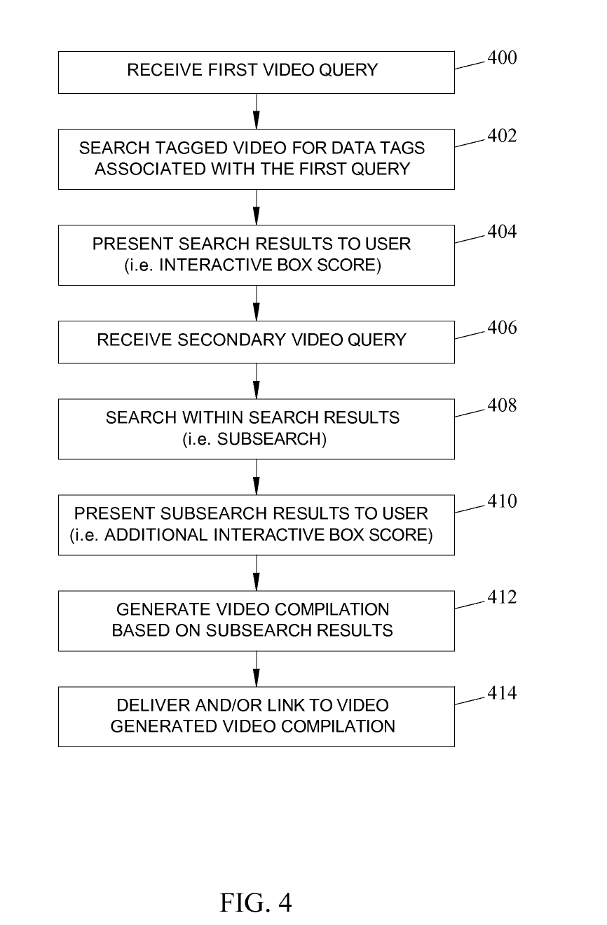

FIG. 4 is a flow chart of exemplary steps for automatically tagging a broadcast video source according to an embodiment of the subject matter described herein. Referring to FIG. 4, in block 400, a first video query is received. As mentioned above, this may include single variable or multivariate search criteria. For example, a user may wish to view all of Alex Rodriguez's at bats. Or more specifically, the user may wish to only view Alex Rodriguez's at bats which occurred during the past week in which he hit a home run.

In block 402, tagged video may be searched for data tags associated with the first query. A database containing factually tagged media clips may be searched via, for example, a structure query language (SQL) query based on the factual tags associated with media clips.

In blocks 404 and 406, search results associated with the first query may be presented to the user and a second video query may be received for searching within the first search results (i.e. subsearching). For example, search results may be displayed graphically in the form of a game “interactive box score” that will be familiar to sports fans, but the numerical data output shown in this interactive box score (e.g. shots, 3-point shots, rebounds, assists, etc.) may be direct links to the video whose results comprised the statistic. A user may examine this interactive box score (or any other interactive box score which may be the end result of a user-based search) and determine that they wish to see all 9 offensive rebounds in the game by player “T. Hansbrough.” By clicking on the number 9 using a cursor, the user activates the search for these live-action video clips.

In another scenario, if a user decides to search on a multivariate selection (e.g. fantasy points generated by players who are guards) the subject matter described herein may not only compile the proper live action video which results from searching the meta-data, but may automatically generate a new interactive box score for that search. In other words, the subject matter described herein allows one to search the video using tagged meta-data which then compiles the proper video and generates a new interactive box score which relates only to the original video search.

In blocks 408 and 410, a subsearch may be performed and the subsearch results may be presented to the user via a second interactive box score.

In block 412, a video compilation comprising one or more media portions may be generated based on the subsearch results. For example, if the first search produced 100 video clips matching the first search criteria and the subsearch produced just 10 video clips, then those 10 video clips may be compiled into media presentation for delivery to the user's display device.

Finally, in block 414, the generated video compilation may be delivered to the user via one of direct streaming or a hyperlink embedded in an email, SMS message, etc. In one embodiment, the user may click on a hyperlink for launching a media player operating on his or her display device, where the media player is configured to receive a video stream corresponding to the media presentation indicated by the hyperlink.

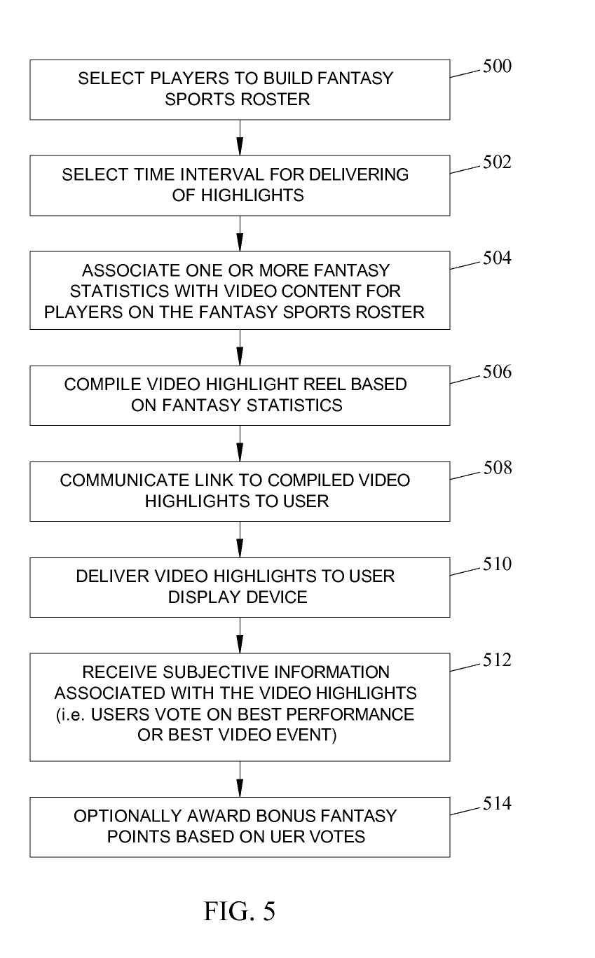

FIG. 5 is flow chart of exemplary steps for performing nested searches and displaying an interactive box score according to an embodiment of the subject matter described herein. Referring to FIG. 5, in block 500, one or more players are selecting for building a fantasy sports roster. In this embodiment of the subject matter described herein, users log-in to the site and are able to compile a fantasy team of players by using search tools, drop down menus, questionnaires, or other standard data selection methods. In one embodiment of a new fantasy sports game which incorporates video highlights according to the subject matter described herein, a fantasy sports game/league is created by a set of fantasy owners. Each fantasy owner drafts their team in the league and begins to compete with other owners based on fantasy points generated (as defined by the rules of the specific league). Team performance and highlights are tracked and the video can be searched as previously described herein.

In block 502, a time interval is selected for delivering highlights associated with the fantasy sports roster generated in block 500. For example, once a fantasy sports roster is built, then the user may select a time interval under which highlights will be generated. This interval may be daily, twice a week, weekly, monthly, or any other interval desired by the user. The website will update player statistics (either in real time, post-game, or daily) and automatically calculate the number of fantasy points related to each statistic. The user, or group of users in any league, or the owner of the website may define and prioritize how the highlights are selected using the performance categories in the game and how many highlights may be generated per week. By example, in a baseball league, the video clips most likely would involve home runs hit. Given that many games have multiple home runs hit, the user (or website owner) could prioritize the home runs for the purpose of generating a video compilation of suitable size. One embodiment may be to determine that home runs will be shown in decreasing degree of importance to the game. For example, game winning home runs and grand slams might always make the highlight compilation, followed by 3-run home runs, 2-run home runs, and finally solo home runs.

In block 506, upon reaching the appropriate time interval as selected the subject matter described herein will automatically generate video clip highlights of the team over that time interval. Thus, if the time interval selected by the user is weekly, then every Monday morning the user may receive highlights based on his or her search criteria for the previous week. This may be done automatically, for example, by sending an email to the user that includes an embedded hyperlink for displaying the media presentation.

In block 508, a notification may be sent to the fantasy owner indicating that their video highlight compilation is ready. For example, the notification may include, but not limited to, an email, SMS message, MMS message, webpage, RSS feeds, etc. In block 510, the fantasy owner can follow this notification (via hyperlink or other search tag) and immediately launch and see the video highlights of their fantasy team on any display device. In one embodiment, a link may be located on the home screen of a mobile smartphone, such as the iPhone produced by Apple, Inc. of Cupertino, Calif. When the user clicks on this link, video highlights corresponding to his or her fantasy sports roster may be automatically streamed to their handset.

In block 512, subjective information associated with the video highlights may also be received for providing users with the ability to vote on their favorite or most amazing sports performances. This may add an additional level of excitement to the fantasy sports game that is possible due to the integration of the video highlights and factually tags for individual highlights. In an embodiment of the subject matter described herein, fantasy owners would have the option to “vote” on the highlights generated by their team members after viewing the video. Such votes may include “play of the day/week/month/year”, “most amazing run”, or other objective or subjective criteria as defined by the game owner.

Optionally, in block 514, additional fantasy points may be awarded based on the subjective information received in block 512. For example, videos which receive the most votes (or the most links, etc.) can be awarded supplementary fantasy points. This embodiment, not currently a component of any fantasy game, adds a new level of excitement and competition to the game as points are highly valued and a video clip that wins a vote could provide the additional points necessary for a player to win that week's competition.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A method for providing dynamic user access to factually tagged time-based portions of a media presentation, the method comprising:
dividing a media presentation into media portions, wherein dividing a media presentation into media portions includes dividing the media presentation of a sporting event into individual plays;
factually tagging the media portions, wherein factually tagging the media portions includes factually tagging the individual plays according to different play types;
storing the factually tagged media portions in a database; and
providing, via a fantasy sports game interface, dynamic user access to the factually tagged media portions in the database where the user engages in a dialogue with at least one server associated with the database and retrieves types of plays of interest to the user of the media presentation in response to user queries including the tags for the different play types.

2. The method of claim 1 wherein dividing the media presentation into media portions includes dividing substantially all of the media presentation into media portions.

3. The method of claim 1 wherein dividing the media presentation into time-based media portions includes limiting a time duration of each media portion.

4. The method of claim 1 wherein the media presentation comprises a sports event and wherein factually tagging the media portions includes tagging the media portions with player information.

5. The method of claim 1 wherein providing dynamic user access to the factually tagged media portions includes providing for the reception of statistics from the user and collecting media portions from the database based on the statistics.

6. The method of claim 1 wherein providing dynamic user access to the factually tagged media portions includes providing for delivery of the factually tagged media portions to a mobile telephone.

7. The method of claim 1 comprising generating statistics based on media portions retrieved by a user and delivering the statistics to the user.

8. The method of claim 1 wherein factually tagging the media portions includes one of automatically tagging and manually tagging the media portions.

9. The method of claim 1 comprising tagging the media portions with subjective information.

10. The method of claim 9 wherein tagging the media portions with subjective information includes tagging the media portions with one of a number of votes for the media portion, a number of times the media portion is viewed, a number of comments about the media portion, and a number of links to the media portion.

11. The method of claim 1 wherein the media portion is delivered to the user via one of a short message service (SMS) message, a multimedia message service (MMS) message, a uniform resource locator (URL), an email, and a real simple syndication (RSS) feed, through which the user can access the media portions.

12. A method for implementing a fantasy sport-based game including factually tagged time-based portions of a media presentation, the method comprising:
receiving a media presentation;
receiving a fantasy sports event roster of at least one player that participated in the sports event;
dividing the media presentation into media portions, wherein dividing a media presentation into media portions includes dividing the media presentation of a sporting event into individual plays;
factually tagging the media portions, wherein factually tagging the media portions includes factually tagging the individual plays according to different play types and associating the factual tags with the fantasy sports roster corresponding to players in the fantasy sports roster; and
automatically presenting the media types of plays of interest to the user using the factual tags associated with the fantasy sports roster for the different play types.

13. The method of claim 12 wherein receiving a media presentation includes receiving one of digital video, moving picture experts group (MPEG) video, quicktime video, and flash video.

14. The method of claim 12 wherein automatically presenting the media portions includes limiting the presentation of the media portions based on one of a time interval and at least one factual tag.

15. A system for providing dynamic user access to factually tagged time-based portions of a media presentation, the system comprising:
a database embodied in a non-transitory computer-readable medium for storing factually tagged media portions and providing dynamic user access to the factually tagged media portions in the database where the user engages in a dialogue with at least one server associated with the database and retrieves portions of the media presentation and response to user queries; and
a dynamic user access module embodied in the non-transitory computer-readable medium for dividing a media presentation into time-based portions and factually tagging the media portions, wherein the media presentation comprises a sporting event, wherein the time-based portions include individual plays within the sporting event, wherein factually tagging the media portions includes tagging the individual plays according to different play types, and wherein the server provides the user access to plays of interest to the user using the tags for the different play types.

16. The system of claim 15 wherein the dynamic user access module is configured to divide substantially all of the media presentation into media portions.

17. The system of claim 15 wherein the dynamic user access module is configured to limit a time duration of each media portion.

18. The system of claim 15 wherein the dynamic user access module is configured to tag the media portions of a sports event with player information.

19. The system of claim 15 wherein the dynamic user access module is configured to receive statistics from the user and collect media portions from the database based on the statistics.

20. The system of claim 15 wherein the dynamic user access module is configured to deliver the factually tagged media portions to a mobile telephone.
